(19) United States
(12) Patent Application Publication
(10) Pub. No.: US 2017/0002556 A1
(43) Pub. Date: Jan. 5, 2017

(54) Magic Water Saver

(71) Applicant: Dennis Lowell Lukes, Des Moines, WA (US)

(72) Inventor: Dennis Lowell Lukes, Des Moines, WA (US)

(21) Appl. No.: 15/167,171

(22) Filed: May 27, 2016

Related U.S. Application Data
(60) Provisional application No. 62/186,665, filed on Jun. 30, 2015.

(51) Int. Cl. E03D 1/38; F16L 55/07

(52) U.S. Cl. CPC E03D 1/38; F16L 55/07; G01F 1/00

(57) ABSTRACT

The Magic Water Saver is designed for tank-style toilets, and replaces the standard refill tube that runs from the fill valve to the overflow tube. The Magic Water Saver is defined as a continuous water volume control device within a tube connector that is specifically designed to reduce the flow of water in low-pressure water systems. This product is ideally suited for use in tank-style toilets by reducing the excess flow of water from the fill valve to the overflow tube. Average water savings using the Magic Water Saver is approximately a ½ gallon per flush. The Magic Water Saver is comparable to other refill tubes on the market, but its unique function of using continuous restrictive flow technology makes it superior as an environmentally-friendly, no-hassle, ‘plug-and-play’ water conservation product.

### BACKGROUND

Dennis Lukes formulated the idea for the Magic Water Saver after tinkering and doing many odd jobs for friends, family, and businesses over a 50 year career of service to others. He was working on the toilets of an apartment complex, and decided to explore methods for reducing water consumption without the residents being affected. Dennis had already seen the failures of the low-flow shower heads, and did not want to repeat that model. He determined that reducing the water at the source point rather than at the utilization point was the best option for optimal usage while conserving resources. He developed a prototype Magic Water Saver using an air valve and plastic tubing that provided just the right amount of counter-pressure to the fill valve of the toilet as it refilled from the water line. That counter pressure reduced the excess water flowing to the overflow pipe, through the back trap, and into the bowl or vent trap depending on the type of toilet. Once he confirmed that he could reduce the total volume of water without reducing the functionality of the tank or bowl, he designed an improved water volume control device that would perform better than the air valve, and began testing the new valve. For a 30 second refill of a tank-style toilet, the Magic Water Saver will save ˜0.5 gallons per flush without affecting the functionality of the tank or bowl.

### DESCRIPTION OF THE MAGIC WATER SAVER AS LABELED IN MECHANICAL DRAWINGS

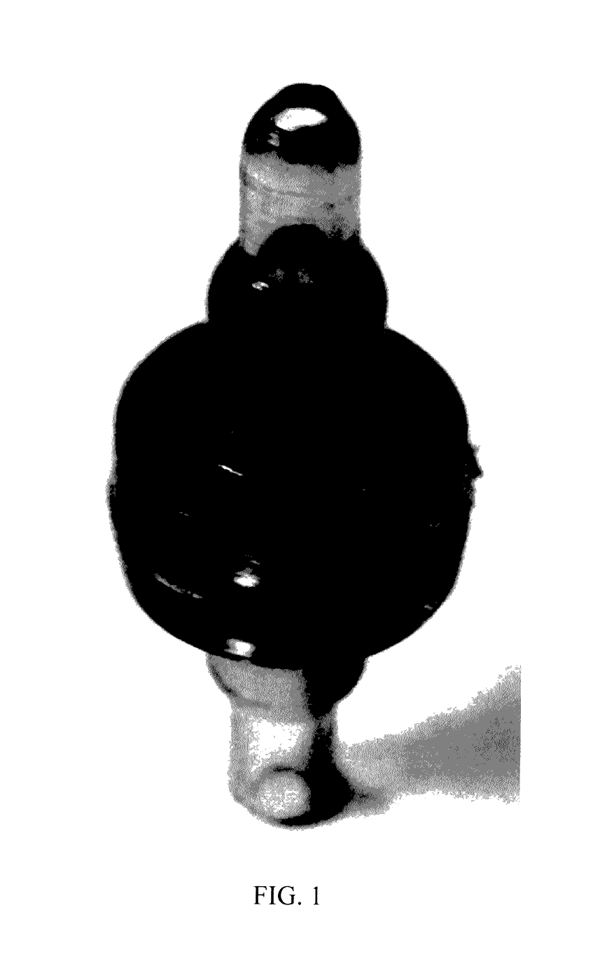

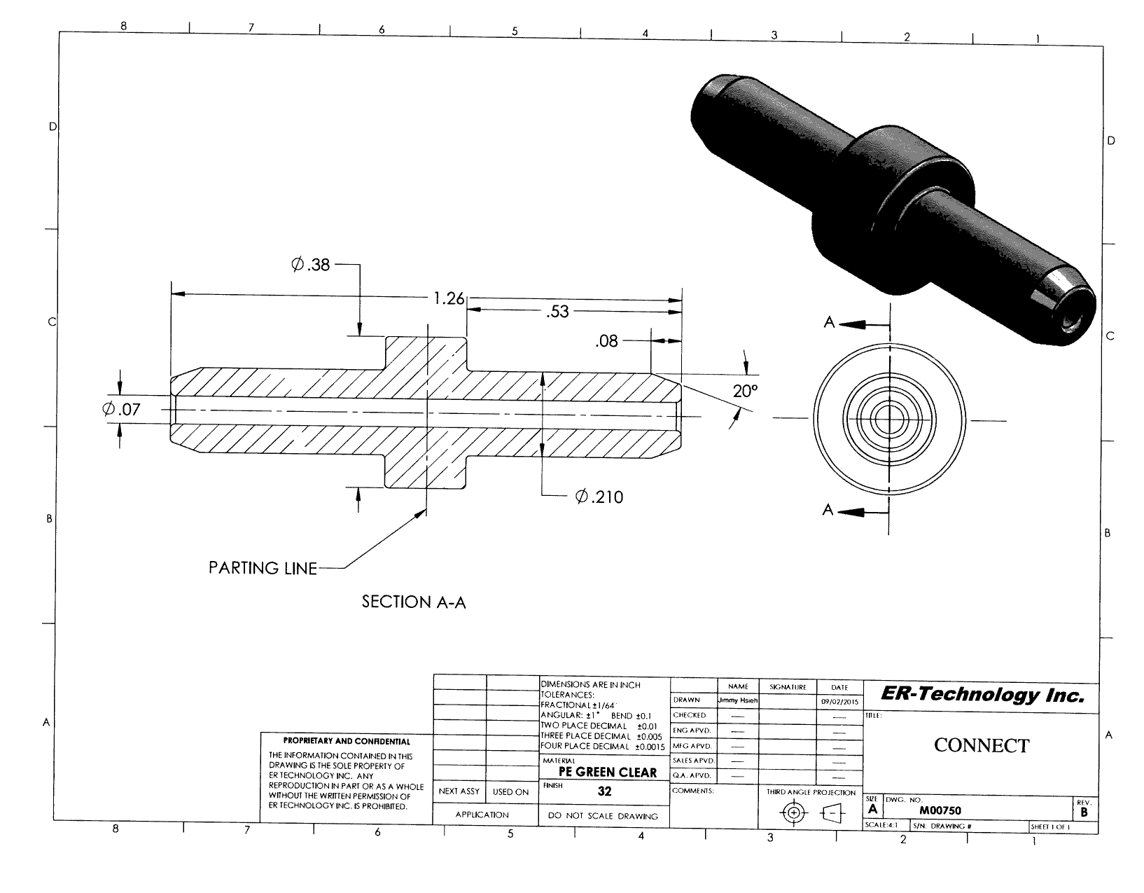

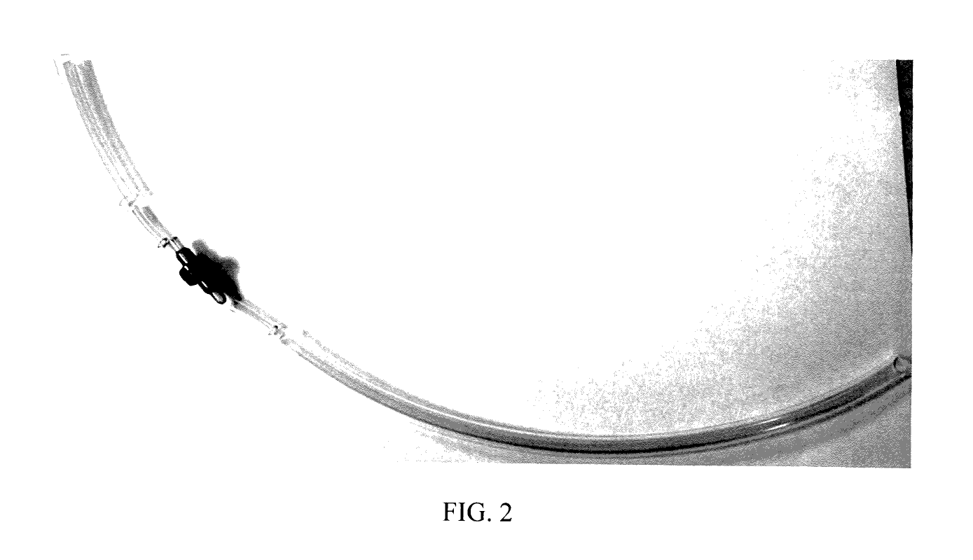

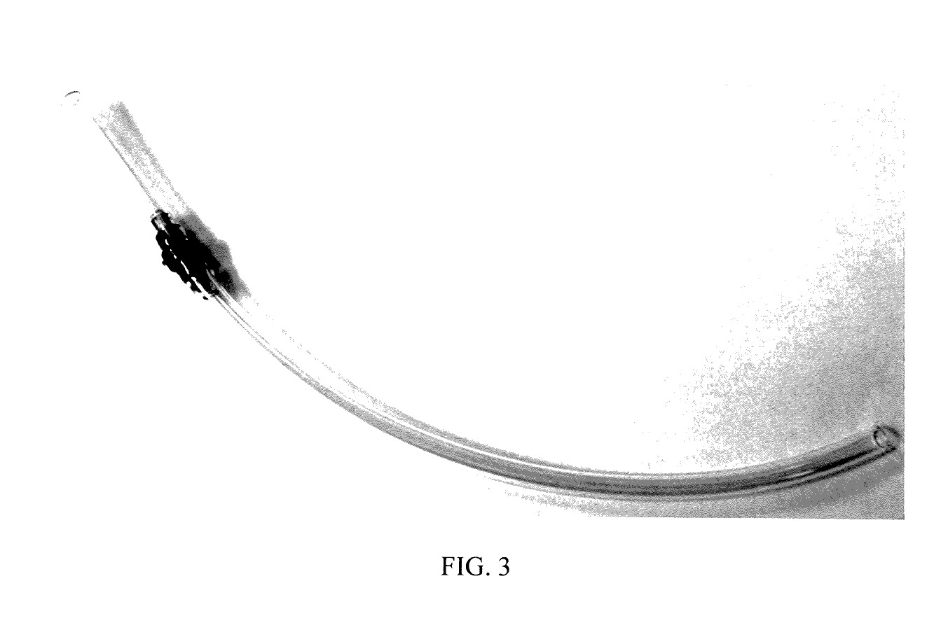

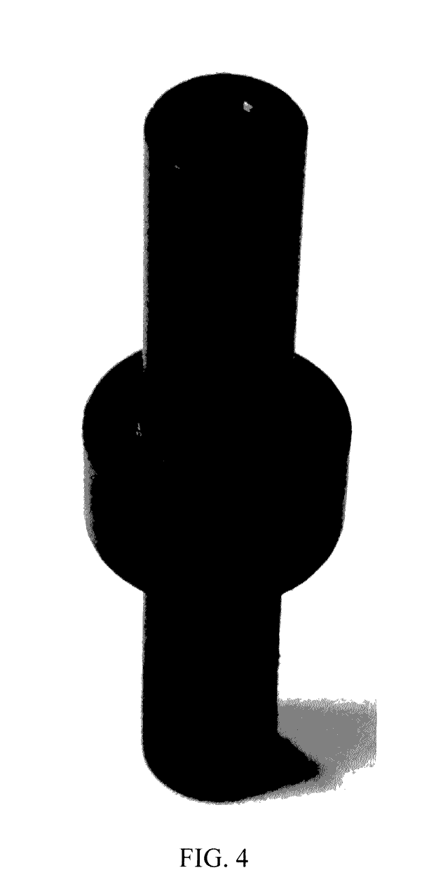

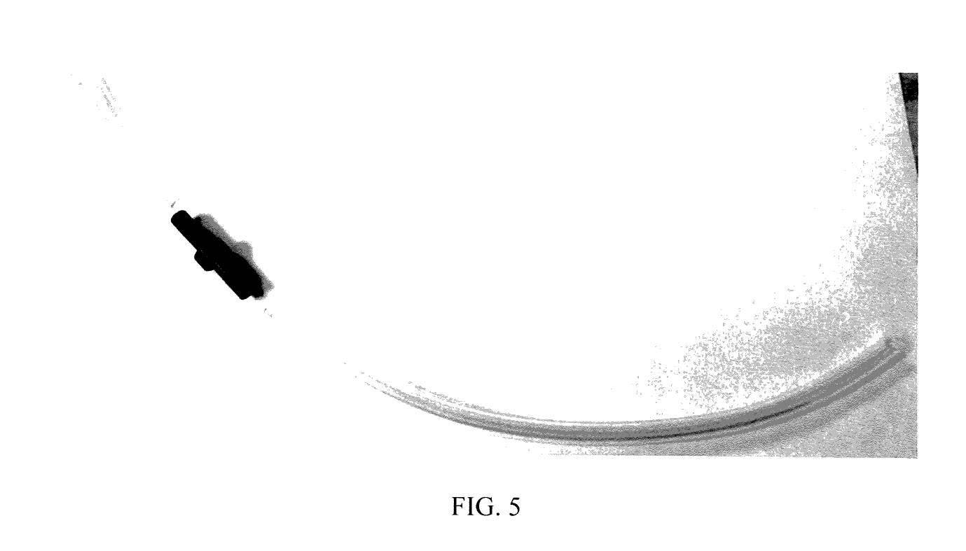

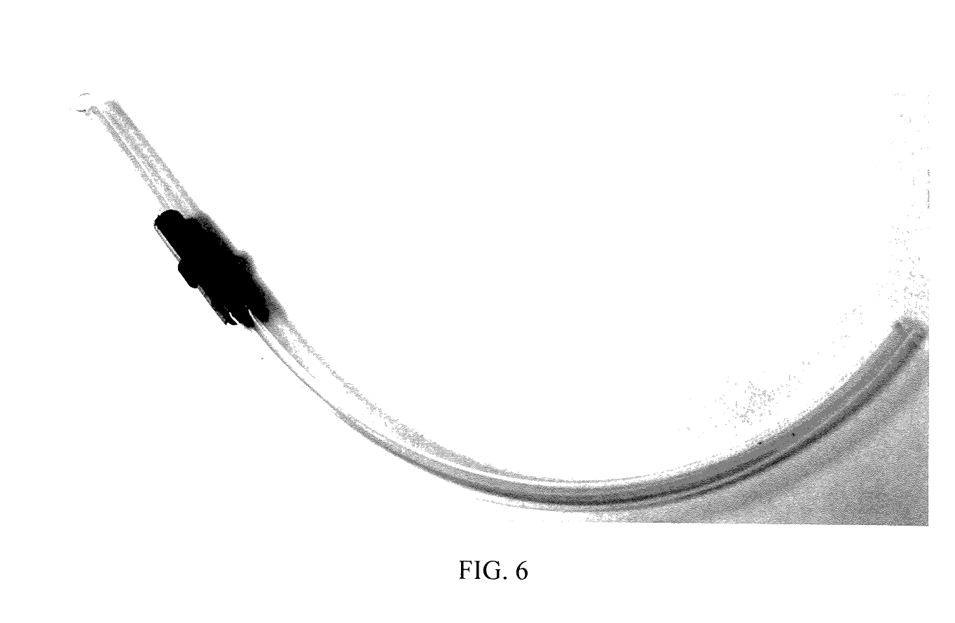

FIG. 1—Water volume control device as drawn by ER Technology (Drawing #M₀₀₇₅₀)

### DETAILED DESCRIPTION

Product is a refill tube with a continuous water volume control device for tank-style toilets. Product installs with two simple steps, and reduces an average of a half-gallon of water per toilet flush. Product is compatible with all other water savers on the market, and proves immediate and long-lasting benefit. The Magic Water Saver is defined as any water conservation product that uses the custom-designed continuous water volume control device with any combination of tubing to reduce water in tank-style toilets or other plumbing fixtures.

Product is made of molded plastic. The preferred tubing is food-grade plastic that fastens to the continuous water volume control device by slipping over the protruding ends of the tube connection stem.

Product contains no lead or other harmful materials.

1. A Magic Water Saver is defined as a refill tube with a continuous water volume control device for tank-style toilets, said continuous water volume control device is comprised of molded plastic or other moldable material including a 2-3 inch tube connected to a tube connection stem and a 6-9 inch tube connected to the other tube connection stem, said continuous water volume control device having a 20 degree beveled edge (0.08 inch width or 2.03 millimeters) on the total circumference of both ends to facilitate slip-on tube connection, said continuous water volume control device is bored or molded with a 0.07 inch (1.78 millimeter) aperture clear through the middle interior of the valve, said continuous water volume control device measuring no less than 1.26 inches (32.00 millimeters) in overall length, 0.53 inch (13.46 millimeters) length on each tube connection stem protrusion, 0.38 inch (9.65 millimeter) wide tube stop positioned in the middle of the water control device, and a width of 0.21 inch (5.33 millimeters) on the tube connection stems with a 0.39 inch (10 millimeters) tube stop width. Color can be varied and made to order.

2. This product has not been reproduced or distributed in any existing plumbing or water conservation market nationally or internationally. No permission has been granted—written or otherwise—by the inventor for production or replication of this product in any form without express written consent of Dennis Lukes.
